(19) United States
(12) Patent Application Publication
(10) Pub. No.: US 2010/0227973 A1
(43) Pub. Date: Sep. 9, 2010

(54) LOW VISCOSITY POLYAMIDES

(75) Inventors: John V. Facinelli, Morristown, NJ (US); David Loy, Richmond, VA (US); Timothy Kraft, Pompton Plains, NJ (US); John Mattson, Chester, VA (US)

Correspondence Address: HONEYWELL/FAEGRE;Patent Services, 101 Columbia Road, P.O. Box 2245, Morristown, NJ, 07962-2245, US

(73) Assignee: Honeywell International Inc., Morristown, NJ (US)

(21) Appl. No.: 12/718,402

(22) Filed: Mar. 5, 2010

Related U.S. Application Data
(60) Provisional application No. 61/158,269, filed on Mar. 6, 2009.

(51) Int. Cl. C08L 77/00; C08G 69/02; C08G 69/14

(52) U.S. Cl. 524/606; 528/310; 528/323

(57) ABSTRACT

A polyamide having a viscosity of between about 20 and about 40 FAV and a number average molecular weight of between about 9,000 and about 16,000 grams per mole is provided. The polyamide also includes un-terminated endgroups, where a difference between a concentration of carboxylic acid endgroups and a concentration of amine endgroups is about 5 meq/kg or less.

### CROSS REFERENCE TO RELATED APPLICATIONS

This application claims the benefit of Provisional Application Ser. No. 61/158,269, filed on Mar. 6, 2009, entitled “Low Viscosity Polyamides” which is herein incorporated by reference in its entirety.

### FIELD OF THE INVENTION

The present invention is generally related to the field of polyamides. In particular, the present invention is related to low viscosity, un-terminated polyamides.

### DESCRIPTION OF RELATED ART

Stable low molecular weight and low viscosity polyamides, such as nylon-6, are utilized in engineering plastics and textile applications. In the area of engineering plastics, the polyamides may be utilized in applications requiring high loadings or fillers (glass fiber or mineral) which are typically added by high shear mixing in the melt phase and then pelletized in solid form prior to the injection molding step. Some of these applications, such as injection molding, require the polyamide base resin to possess high flow characteristics to aid the production of thin walled parts with a large surface area, or to facilitate high loadings of glass or mineral fillers.

The low molecular weight, low melt viscosity polyamides have conventionally been produced using caprolactam and a small percentage of water which acts as a hydrolytic initiator. The commercially produced polyamides typically contain mono-functional termination which may be utilized to slow the kinetics of polymerization and achieve the target molecular weight or target melt or solution viscosity. The termination chemistry may be achieved using small amounts of mono- or di-functional acids or amines to reduce the resultant polyamide's carboxylic acid and amine endgroup concentrations which are considered in the art to be the partial termination of the active carboxylic acid and amine endgroups of the polyamide. In one embodiment, the termination chemistry for producing the polyamide includes using an acid, such as acetic acid, to reduce amine endgroups and terminate the polymer. This reduction in the concentration of functional endgroups is thought to enhance melt stability by reducing the concentration of active species and the rates of reactions. In one example, the rate of amide group hydrolysis is reduced when a polyamide is terminated. In another example, the mono-functional termination of the polyamide is utilized to decrease the kinetic rate of polymerization to achieve a desired formic acid viscosity (FAV). This results in a polyamide having high melt stability and melt flow properties.

### SUMMARY OF THE INVENTION

In one aspect, the present invention is a polyamide having a viscosity of between about 20 and about 40 FAV and an average molecular weight of between about 9,000 and about 16,000 grams per mole. The polyamide also includes a concentration difference between carboxylic acid endgroups and amine endgroups of about 5 meq/kg or less.

In another aspect, the present invention is a low viscosity and low number average molecular weight polyamide formulation including a polyamide and an additive. The polyamide has a viscosity of between about 20 and about 40 FAV, an average molecular weight of between about 9,000 and about 16,000 grams per mole and a concentration difference between carboxylic acid endgroups and amine endgroups of about 5 meq/kg or less.

### BRIEF DESCRIPTION OF THE DRAWINGS

FIG. 1 is a graph showing the capillary rheology of vacuum dried nylon-6 pellets.

FIG. 2 is a graph showing the capillary rheology of moisture conditioned nylon-6 pellets.

FIG. 3 is a graph showing the capillary rheology of a commercially available terminated, low viscosity nylon-6 pellet.

FIG. 4 is a graph showing the capillary rheology of a terminated, low viscosity nylon-6 pellet.

FIG. 5 is a graph showing the capillary rheology of an un-terminated, medium viscosity nylon-6 pellet.

FIG. 6 is a graph showing the capillary rheology of an un-terminated, low viscosity nylon-6 pellet.

### DETAILED DESCRIPTION

The composition of the present invention is a stable, un-terminated polyamide having low viscosity and a low number average molecular weight. Surprisingly, it has been found that low viscosity, un-terminated polyamides exhibit similar melt stability and melt flow properties as low or medium viscosity, terminated polyamides. Un-terminated polyamides having high melt flow and melt stability properties simplify industrial processing and reduce the number of materials needed to produce the base polyamide. In one embodiment, the polyamide is a low viscosity, un-terminated nylon-6.

As previously mentioned, termination of a polyamide results in the reduction of the concentration of functional carboxylic acid and amine endgroups. A polyamide is considered to be un-terminated when the actual difference between the concentration of carboxylic acid endgroups and the concentration of the amine endgroups is equal to about 5 meq/kg or less. These concentrations may be determined using titration and measuring the concentrations color-metrically or potentio-metrically. When the concentrations are measured using color-metrics, the measured concentration difference may be higher than the actual difference. A polyamide is also considered to be un-terminated when either the amine endgroup concentration or the carboxylic acid endgroup concentration is used to accurately calculate the number average molecular weight of the polyamide.

One method of measuring the viscosity of the low viscosity, un-terminated polyamide is the Formic Acid Viscosity (FAV). Determining FAV is standardized in ASTM D789-07. The viscosity of the low viscosity, un-terminated polyamide depends on a number of factors, including the residual extractable content. In turn, the residual extractable content depends on the degree of leaching. Before leaching, a low viscosity, un-terminated polyamide is defined as having “low viscosity” at a FAV of between about 20 and about 33 and particularly between about 24 and about 28. An unleached, low viscosity, un-terminated polyamide typically has up to about 12% extractables. A low viscosity, un-terminated polyamide that is leached is defined as having “low viscosity” at a FAV of between about 30 and about 40 and particularly between about 32 and about 39. A leached low viscosity, un-terminated polyamide typically has less than about 2% extractables and particularly less than about 1.5% extractables.

The viscosity of a polyamide is also related to the number average molecular weight of the polyamide. Generally, as the number average molecular weight of the polyamide decreases, the viscosity of the polyamide also decreases. In one embodiment, the number average molecular weight of the polymer component of the low viscosity, un-terminated polyamide of the present invention is between about 9,000 and about 16,000 grams per mole (g/mol). The molecular weight of the “polymer component” only refers to the polymerized component of the polyamide composition and not residual monomer, oligomer or other residual components. In particular, the number average molecular weight of the polymer component of the low viscosity, un-terminated polyamide of the present invention is between about 13,000 and about 15,000 g/mol.

Surprisingly, the hydrolytic melt stability of a low viscosity, un-terminated polyamide was found to be substantially similar to the hydrolytic melt stability of an equivalent low viscosity, terminated polyamide. For example, a low viscosity, un-terminated nylon-6 of the present invention has hydrolytic melt stability substantially similar to a low viscosity, terminated nylon-6. It had been previously thought that termination was required to achieve hydrolytic melt stability. As shown in the examples below, it has been surprisingly found that an un-terminated, low viscosity polyamide also exhibits high hydrolytic melt stability. The melt stability of the polyamide can be determined by any method known in the art, such as for example, capillary rheology as a function of time

In addition, at a FAV range of between about 30 and about 40, the leached, low viscosity, un-terminated polyamide of the present invention has enhanced melt flow performance compared to the industry standard medium viscosity, compounding grade nylon 6.

The starting materials for forming a low viscosity, un-terminated polyamide include a lactam, water and/or an aminocarboxylic acid. Exemplary lactams include, but are not limited to: caprolactam, valerolcatam, enantholactam, capryllactam, undecalactam and laurolactam. A particularly suitable lactam is caprolactam. When caprolactam is used, the water content of the caprolactam is between about 0.5% and about 3%. Exemplary aminocarboxylic acids include, but are not limited to: aminocaproic acid (ACA), aminoheptanoic acid, aminooctanoic acid, aminononanoic acid, aminodecanoic acid, aminoundecanoic acid, and aminiododecanoic acid. A particularly suitable aminocarboxylic acid is aminocaproic acid. When caprolactam and/or aminocaproic acid are used as the starting materials, nylon-6 is produced. Depending on the starting materials used to form the polyamide, the polyamide composition may include lactam and aminocarboxylic acid fragments.

The low viscosity, un-terminated polyamide generally includes a lactam, water and/or an aminocarboxylic acid. Suitable component concentrations for the low viscosity, un-terminated polyamide range from between approximately 85% and approximately 100% by weight of a lactam, up to approximately 5% by weight water, and up to approximately 10% by weight aminocarboxylic acid. Those skilled in the art will appreciate other suitable component concentration ranges for obtaining comparable properties of the solidification matrix.

In an alternative embodiment, the starting material(s) can be made from hydrolysis of a lactam. In yet another alternative embodiment, the object of the invention can be made through polycondensation of an aminocarboxylic acid.

Once the base polyamide has been formed, various additives can be added to enhance particular properties of the polyamide. In this way, the polyamide can be manipulated to exhibit particular mechanical properties that are suitable or desirable for a particular commercial application. For the purpose of this application, the term “additive” includes a material that when dispersed or dissolved in the composition, provides a beneficial property for a particular use. Exemplary additives include, but are not limited to: antioxidants, thermal stabilizers, anti-weathering agents, mold releasing agents, lubricants, pigments, dyes, nucleating agents, plasticizers, antistatic agents, flame retardants, glass fillers, mineral fillers, UV stabilizers and impact modifiers.

Lubricants can optionally be added to the low viscosity, un-terminated polyamide to improve processability. Exemplary lubricating additives include, but are not limited to: ethylene-bis-stearamide, zinc stearate, magnesium stearate, calcium stearate, sodium stearate, polydimethylsiloxane, polyolefin, ethylenevinylacetate copolymers.

Nucleating additives can optionally be added to the low viscosity, un-terminated polyamide to modify crystallization of the polyamide. Exemplary nucleating additives include, but are not limited to, talc and silicon dioxide.

Heat stabilizer additives can optionally be added to the low viscosity, un-terminated polyamide to stabilize the polyamide at high temperatures. Exemplary heat stabilizer additives include, but are not limited to: Cul, CuBr, KI, KBr, hindered phenols, hindered amines and phosphites.

Fire retardant additives can optionally be added to the low viscosity, un-terminated polyamide to prevent the polyamide from combusting. Exemplary fire retardant additives include, but are not limited to: halogenated fire retardant additives, antimony based fire retardant additives, zinc oxide, zinc borate, and phosphate esters.

Impact modifier additives can optionally be added to the low viscosity, un-terminated polyamide to increase the toughness or impact strength of the formed polyamide. Exemplary impact modifier additives include, but are not limited to, maleated polyolefins and EBR rubbers.

### Processing and Applications

Once the polyamide resin is formulated with additives, the product can be processed using any method known in the art. Examples include injection molding, fiber extrusion or film extrusion. The products can also be compounded for engineering plastics or textile applications. Examples of applications for engineering plastics include applications requiring high loadings of fillers and applications requiring high flow characteristics to produce thin walled parts with a large surface area. Examples of these fillers can be glass fibers or minerals.

In one embodiment, polymerization is conducted in a stainless steel agitated reactor equipped with a nitrogen purge and an outlet for strand pelletization. The reactor is charged the day before with about 1500 grams of caprolactam and about 5% (w/w) or 80 grams of aminocaproic acid as an initiator. The reactor is purged overnight with a nitrogen sweep. Heating is then initialized. When the reaction temperature reaches about 160° C., agitation is started. After the reaction reaches a temperature of between about 260 and about 270° C., the temperature is maintained with continued agitation for a predetermined amount of time. Agitation is then stopped and the polymer is strand extruded into a quench water bath (5° C.) and fed into a pelletizer to produce nylon pellets. The nylon pellets are then leached in deionized water having a temperature of between about 90 and about 100° C. to remove the extractables. The nylon pellets are then air dried and subsequently vacuum oven-dried for about 2 days.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

### Low Viscosity Nylon Test

A plurality of low viscosity, un-terminated nylon samples (Examples 1, 2 and 3) and low viscosity, terminated nylon samples (Comparative Examples A and B) were prepared in a 3-liter lab-scale reactor with a target Formic Acid Viscosity (FAV) of 36. The samples were extracted via bench-top leaching with near boiling deionized water having a residual extractables target of about 0.5%. The samples were dried and analyzed by capillary rheometry both before and after moisture conditioning to study the melt stability of the samples in the presence and absence of moisture.

Polymerization of each of the samples was conducted in a stainless steel 3 liter agitated reactor equipped with a nitrogen purge and an outlet for strand pelletization. The reactor was charged the day before with about 1500 grams of caprolactam and about 5% (w/w) or 80 grams of aminocaproic acid as an initiator. The reactor was purged overnight with a nitrogen sweep. For the terminated nylons, about 0.224% (w/w) or 3.6 grams of glacial acetic acid was added to the reactor the following morning using a syringe. Heating was then initialized. When the reaction temperature reached about 160° C., agitation was started. After about 3 to about 3.5 hours, the reaction reached a final temperature of between about 260 and about 270° C.

After maintaining the temperature (with continued agitation) for a predetermined amount of time, agitation was stopped and the polymer was strand extruded into a quench water bath (5° C.) and fed into a pelletizer to produce nylon pellets. The nylon pellets were leached four times for about one hour each time and then one more time for about two hours in deionized water to remove the extractables. The water temperature was maintained in the range of between about 90 and about 100° C. The samples were first air dried and then dried in a vacuum oven for 2 days.

The samples were analyzed both before and after hot water leaching. The concentrations of the carboxylic acid and amine endgroups were measured color metrically using titration. Titration was performed until there was a noticeable color change in the composition.

Tables 1 and 2 summarize the polymerization conditions and results of the samples of Examples 1-3 and Comparative Examples A and B prior to extraction and following extraction, respectively. Results including the FAV, carboxylic acid and amine endgroup concentrations and residual extractables were determined.

TABLE 1

| | Acetic | | Extractable | COOH | NH₂ | |
|---|---|---|---|---|---|---|
| | Acid | FAV | Unwashed | (meq/kg) | (meq/kg) | Polymerization |
| Example | (grams) | Unwashed | (%) | Unwashed | Unwashed | Time (hours) |
| Example 1 | 0 | 36.8 | 14 | 51.6 | 48.2 | 2.5 |
| Example 2 | 0 | 35.2 | 13 | 59.7 | 50.6 | 2 |
| Example 3 | 0 | 22.9 | 12 | 77.4 | 68.5 | 1.5 |
| Comp. | 3.57 | 30.7 | 12 | 64.5 | 23.3 | 4 |
| Example A | | | | | | |
| Comp. | 3.61 | 27.8 | 12 | 68.6 | 26.9 | 5 |
| Example B | | | | | | |

TABLE 2

| | Acetic | | | COOH | NH₂ | |
|---|---|---|---|---|---|---|
| | Acid | FAV | Extractable | (meq/kg) | (meq/kg) | Polymerization |
| Example | (grams) | Washed | Washed (%) | Washed | Washed | Time (hours) |
| Example 1 | 0 | 55.7 | 0.56 | 62.4 | 52.7 | 2.5 |
| Example 2 | 0 | 51.5 | 0.52 | 65.1 | 57.1 | 2 |
| Example 3 | 0 | 32.4 | 0.29 | 85.5 | 74.3 | 1.5 |
| Comp. | 3.57 | 38.3 | 0.52 | 76.1 | 25.1 | 4 |
| Example A | | | | | | |
| Comp. | 3.61 | 36.3 | 0.63 | 75.9 | 28.4 | 5 |
| Example B | | | | | | |

As can be seen by the data in Tables 1 and 2, the differences between the concentration of carboxylic acid endgroups and the concentration of amine endgroups for each of the samples of Examples 1-3, both pre-wash and after washing, were between about 2.5 meq/kg (Example 1, pre-wash) and about 11 meq/kg (Example 3, after washing). By contrast, the differences between the concentration of carboxylic acid endgroups and the concentration of amine endgroups for each of the samples of Comparative Examples A and B, both pre-wash and after washing, were between about 41 meq/kg (Comparative Example A, pre-wash) and about 51 meq/kg (Comparative Example A, after washing). Although on average Examples 1-3 showed a concentration difference of more than 5 meq/kg, these measurements were determined by color-metric titration which tends to produce a higher measured concentration difference than the actual difference. Accordingly, the relative concentration difference demonstrated between the samples of Examples 1-3 and the samples of Comparative Examples A and B confirms that the samples of Examples 1-3 are un-terminated.

The data in Tables 1 and 2 also show that as the polymerization time decreased, the FAV of the samples of Examples 1-3 also decreased. For example, even though the samples of Examples 1 and 3 included substantially similar differences between the concentration of carboxylic acid endgroups and the concentration of amine endgroups after washing, the samples had a difference in FAV of about 23. In particular, the sample of Example 1, which had a polymerization time of about 2.5 hours, had a FAV of about 55.7, while the sample of Example 3, which had a polymerization time of about 1.5 hours, had a FAV of about 32.4.

Additionally, the FAV of all of the samples increased after leaching. Because the extracts are generally lower viscosity and lower number average molecular weight components, removal of the extracts resulted in an increase in the viscosity of the samples. Even after extraction, the sample of Example 3 is still considered a low viscosity polyamide composition with a FAV of 32.4.

### Capillary Rheology Test

The melt viscosity properties of four nylon-6 samples were analyzed by capillary rheology as a function of shear rate for both dry samples and moisture conditioned samples. In particular, the sample of Example 4 included a low viscosity, un-terminated nylon-6. The sample of Comparative Example C included a medium viscosity, un-terminated nylon-6 and the sample of Comparative Example D included a low viscosity, terminated nylon-6. The sample of Comparative Example E included a commercial low viscosity, terminated nylon-6.

The four nylon samples (in pellet form) were vacuum dried at about 100° C. for about 15 hours and then sealed in foil lined bags. A portion of the pellets from each sample were subsequently exposed in air under constant temperature and relatively humid conditions (23±2° C.; 50±5% RH) to increase the moisture content in a controlled manner. Moisture analysis using Karl-Fischer was conducted about every 2.5 to 3 hours in order to achieve the targeted moisture range of about 0.2% to about 0.6%.

Capillary viscosity tests were conducted on the vacuum dried samples having very low moisture levels and on the same samples following moisture conditioning at about 3, 5.5 and 7.5 hours. The capillary rheology tests were conducted in triplicate at 250° C.

Table 3 lists the viscosity and the results of the conditioning and moisture measurements of each of the samples of Example 4 and Comparative Examples C, D and E.

TABLE 3

| | | Moisture Level | Moisture Level After | | |
|---|---|---|---|---|---|
| | | After Drying at | Exposure to 23° C./50% RH | | |
| Example | FAV | 100° C./Vac, 15 hr | 3 hr | 5.5 hr | 7.5 hr |
| Example 4 | 32 | 330 ppm/0.03% | 0.29% | 0.38% | — |
| Comparative | 52 | 270 ppm/0.03% | 0.25% | 0.26% | 0.37% |
| Example C | | | | | |
| Comparative | 38 | 660 ppm/0.07% | 0.35% | 0.44% | — |
| Example D | | | | | |
| Comparative | 36 | 400 ppm/0.04% | 0.20% | 0.28% | 0.39% |
| Example E | | | | | |

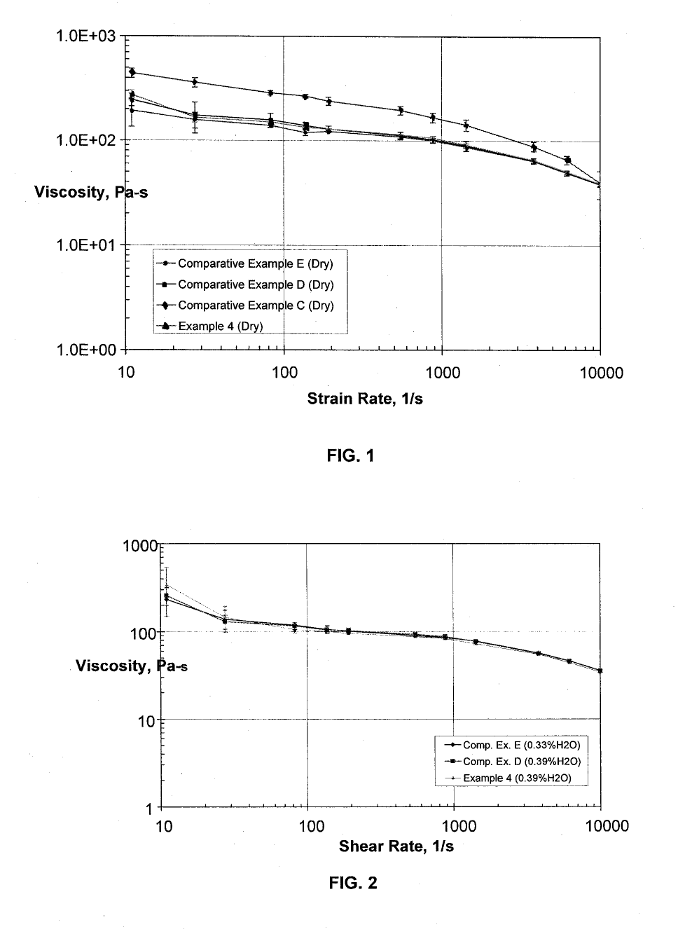

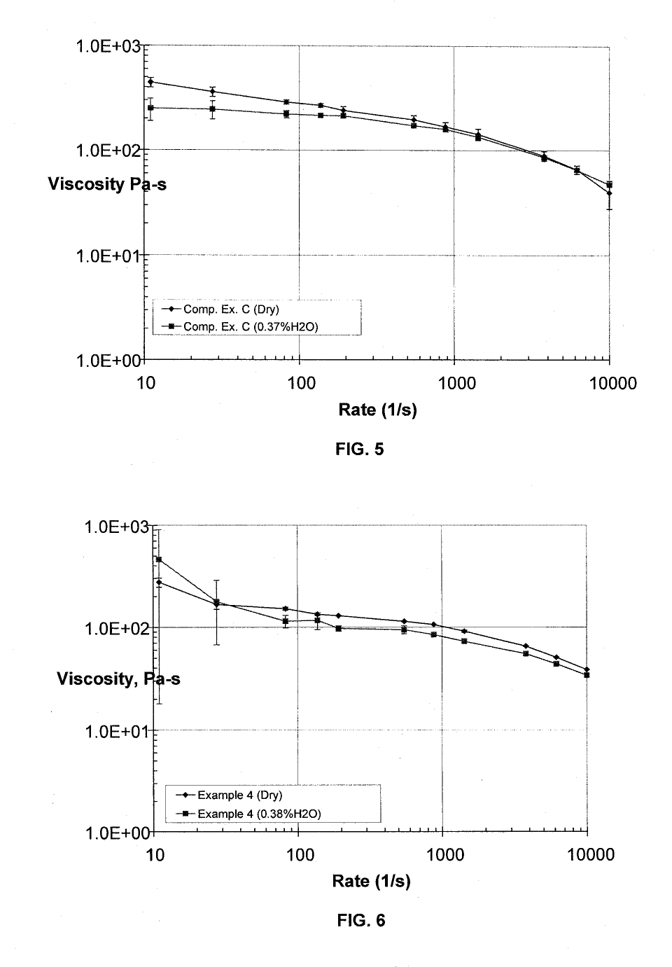

FIGS. 1-6 illustrate that the low viscosity, un-terminated nylon 6 of the sample of Example 4 exhibits a very similar viscosity stability (defined as the viscosity/shear rate behavior before and after moisture conditioning) as the commercially available low viscosity, terminated nylon-6 of the sample of Comparative Example E and the low viscosity, terminated nylon-6 of the sample of Comparative Example D.

As can be seen in FIGS. 1-6, among the four pellet samples, the sample of Comparative Example C exhibited higher viscosity values across the entire shear rate range from 10 to 104 (sec⁻¹) than the samples of Example 4 and Comparative Examples D and E, whose viscosities were found to be very similar across the same shear rate range. This observation was found to be true for both dry samples (FIG. 1) and conditioned samples (FIG. 2). This is explained by the higher viscosity of the sample of Comparative Example C.

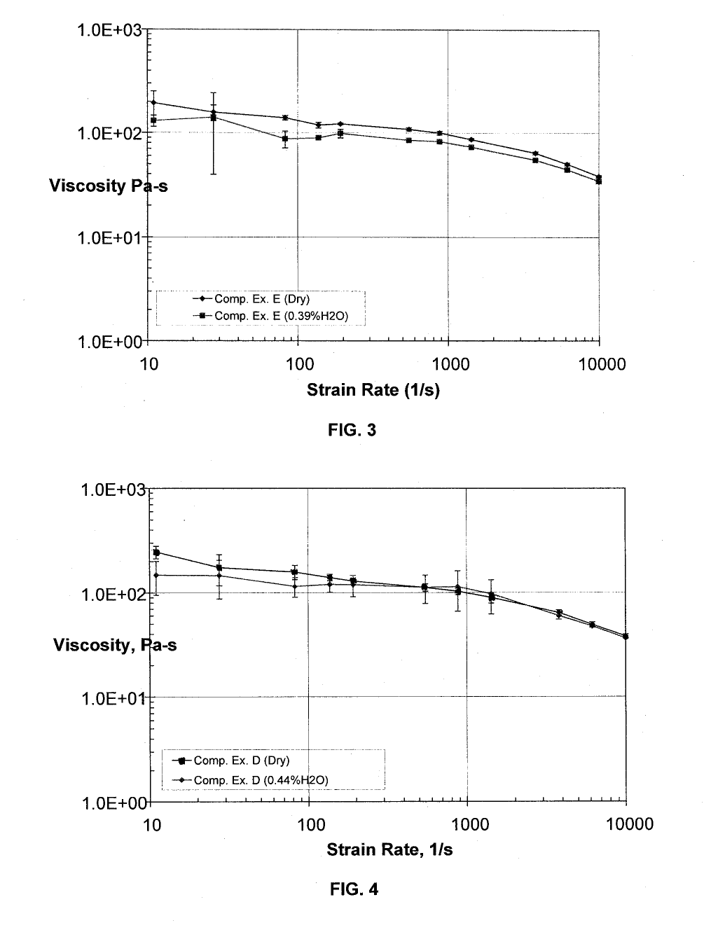

For each sample, moisture conditioning with between about 0.28% and about 0.44% water was found to have the expected effect of lowering the overall viscosity, as shown in FIGS. 3-6. The sample of Example 4, which was a low viscosity, un-terminated polyamide, showed very similar viscosity behavior to the low viscosity, terminated nylon samples of Comparative Examples D and E.

For sufficient industrial melt processability, polyamides such as nylon-6 must typically be dried to moisture levels of below about 0.15%. At moisture levels higher than about 0.15%, the nylon-6 will partially hydrolyze in the melt, resulting in a lower average molecular weight, lower FAV and lower viscosity measured as a function of shear rate. As a result of this physical behavior, nylon-6 can suffer deterioration in processability and physical property performance if not dried properly prior to melt processing.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing, all temperatures are set forth uncorrected in degrees Celsius and, all parts and percentages are by weight, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1. A polyamide comprising:
A. a viscosity of between about 20 and about 40 FAV;
B. a number average molecular weight of the polymer component of between about 9,000 and about 16,000 grams per mole; and
C. a concentration difference between carboxylic acid endgroups and amine endgroups of about 5 meq/kg or less.

2. The polyamide of claim 1, wherein the polyamide has a viscosity of between about 32 and about 39 FAV.

3. The polyamide of claim 2, wherein the polyamide comprises less that about 2% extractables.

4. The polyamide of claim 3, wherein the polyamide comprises nylon 6.

5. The polyamide of claim 1, wherein the polyamide comprises less than about 12% extractables.

6. The polyamide of claim 1, further comprising lactam segments.

7. The polyamide of claim 6, wherein the lactam segments comprise one or more segments of caprolactam, valerolcatam, enantholactam, capryllactam, undecalactam or laurolactam.

8. The polyamide of claim 1, further comprising aminocarboxylic acid segments.

9. The polyamide of claim 8, wherein the aminocarboxylic acid segments comprise one or more segments of aminoheptanoic acid, aminooctanoic acid, aminocaproic acid, aminononanoic acid, aminodecanoic acid, aminoundecanoic acid or aminiododecanoic acid.

10. The polyamide of claim 1, wherein the number average molecular weight of the polymer component is between about 13,000 and about 15,000 grams per mole.

11. A low viscosity and low number average molecular weight polyamide formulation comprising:
A. a viscosity of between about 20 and about 40 FAV;
B. a number average molecular weight of the polymer component of between about 9,000 and about 16,000 grams per mole;
C. a concentration difference between carboxylic acid endgroups and amine endgroups of about 5 meq/kg or less; and
D. at least one additive.

12. The polyamide formulation of claim 11, wherein the at least one additive comprises at least one of: an antioxidant, a thermal stabilizer, an anti-weathering agent, a mold releasing agent, a lubricant, a pigment, a dye, a nucleating agent, a plasticizer, an antistatic agent, a flame retardant, a UV stabilizer and a filler.

13. The polyamide formulation of claim 11, wherein the polyamide formulation comprises less than about 12% extractables.

14. The polyamide formulation of claim 11, wherein the polyamide formulation comprises less than about 2% extractables.

15. The polyamide formulation of claim 11, wherein the polyamide formulation has a viscosity of between about 32 and about 39 FAV.

16. The polyamide formulation of claim 11, wherein the polyamide formulation has a number average molecular weight of the polymer component of between about 13,000 and about 15,000.

17. The polyamide formulation of claim 11, wherein the polyamide formulation comprises nylon-6.
